(19) United States
(12) Patent Application Publication
(10) Pub. No.: US 2018/0240367 A1
(43) Pub. Date: Aug. 23, 2018

(54) MULTI-LEARNING INCUBATING DEVICE AND MULTI-LEARNING SYSTEM INCLUDING SAME

(71) Applicant: Byung Tae KIM, Gangwon-do (KR)

(72) Inventor: Byung Tae KIM, Gangwon-do (KR)

(21) Appl. No.: 15/550,020

(22) PCT Filed: Feb. 5, 2016
(86) PCT No.: PCT/KR2016/001284

§ 371 Date: Aug. 9, 2017

(30) Foreign Application Priority Data
Feb. 10, 2015 (KR) 10-2015-0020333

(51) Int. Cl. G09B 23/36; G09B 5/06; G09B 9/00

(52) U.S. Cl. CPC G09B 23/36; G09B 9/00; G09B 5/06

(57) ABSTRACT

According to a feature of the present invention, a multi-learning incubating device is provided, the device comprising: a virtual incubation egg (100) including a case (110) having an egg shape and having an egg connector (111) mounted on one side thereof for inputting and outputting data, an egg control part (120) for executing a multi-learning program for nurturing and educating a character relating to an animal from which the egg hatches, a display (130) for outputting the executed multi-learning program and a character image, and an operating means (140) for outputting a learner input signal so as to operate the multi-learning program; and a connecting module (200) having a loading space (210) in which the virtual incubation egg (100) can be disposed, having, within the loading space (210), a first module connector (220) signal-connected to the egg connector (111) so as to connect the virtual incubation egg (100) to a module, and having a second module connector (230), mounted on one side thereof, for linking the multi-learning program of the virtual incubation egg (100) with a main server (400) by being signal-connected to a learner terminal (500) connected to the main server (400).

### TECHNICAL FIELD

The present invention relates to a multi-learning incubation device and a multi-learning system including the same and, more particularly, to a multi-learning incubation device capable of generating a character related to an animal hatched out from a corresponding egg using a virtual incubation egg and enabling various types of learning, such as subject learning, foreign language learning and hobby learning including incubation learning, while breeding the corresponding character through learning activities with a learner, and a multi-learning system including the same.

### BACKGROUND ART

In general, an incubator is an apparatus for artificially incubating an incubation egg, and provides an optimum environment for incubation by taking into consideration several factors that affect the incubation of an incubation egg, such as humidity, temperature and the whole egg, as if a parent bird incubates an incubation egg.

Such an incubator is used for learning so that infants and students can learn the incubation process and incubation learning information of an incubation egg in a kindergarten, a school, etc.

In general, however, after an incubation egg is spawned and seated in an incubator depending on the type of incubation egg, the egg rarely has an external change for a specific incubation period (about 21 days in the case of an egg). After the incubation period elapses, the shell of the egg is broken to generate an external change. If a young student, for example, is impatient, he or she will feel boring during the incubation period. Accordingly, there is a problem in that an interest and learning efficiency for incubation learning are reduced.

Furthermore, in order to check that a current incubation state belongs to which process of the entire incubation process, when incubation will be performed and a current internal state, reference books, Internet data, etc. related to the incubation must be reviewed.

Furthermore, if an incubation egg dies while it is artificially hatched using a conventional incubator, it may serve as a negative factor for a young learner who is not stable psychologically and spiritually.

Furthermore, although incubation is successful, a hatched animal may easily die because it does not continue to be managed. There is a problem in that a hatched animal does not continue to be bred and is discarded due to noise, smell, etc. attributable to the cry or excreta of the hatched animal. Accordingly, erroneous recognition for the sanctity of life may be stamped on a learner whose values start to be formed.

Furthermore, the conventional incubator enables only incubation learning related to an incubation process and is problematic in that it has low utilization because other functions are not added.

### DISCLOSURE

### Technical Problem

The present invention has been made to solve the above problems and an object of the present invention is to provide a multi-learning incubating device, which enables education for an incubation process or incubation learning and does not have a foolproof way that an incubation egg or hatched animal dies or is discharged by displaying a process of generating a character related to an animal hatched out from an egg using a virtual incubation egg and of breeding the character in an image, text, voice or dialogue form in accordance with an incubation process of incubating the actual egg of the corresponding animal by counting time from a point of time at which the corresponding character is generated, and a multi-learning system including the same.

Furthermore, another object of the present invention is to provide a multi-learning incubation device capable of providing various sides of education effects by providing a learner with various types of multi-learning content, such as subject learning, language learning, hobby learning and culture activity learning necessary for the learner, including incubation learning and of improving an education effect because it can provide interesting game to the learner in association with learning content, and a multi-learning system including the same.

### Technical Solution

In accordance with a characteristic of the present invention, there is provided a multi-learning incubating device, including a virtual incubation egg 100 including a casing 110 having a shape of an egg and having an egg connector 111 for data input/output mounted on one side thereof, an egg control unit 120 executing a multi-learning program for incubating and educating a character related to an animal hatched out from the egg, a display 130 outputting the executed multi-learning program and a character image, and manipulation means 140 outputting a learner input signal for manipulating the multi-learning program; and a connecting module 200 in which a loading space 210 where the virtual incubation egg 100 is capable of being disposed is disposed, in which a first module connector 220 signal-connected to the egg connector 111 connecting the virtual incubation egg 100 to the module is disposed within the loading space 210, and in which a second module connector 230 signal-connected to a learner terminal 500 connected to a main server 400 for interlocking the multi-learning program of the virtual incubation egg 100 and the main server 400 is disposed on one side thereof.

In accordance with another characteristic of the present invention, there is provided a multi-learning incubation device in which a plurality of the second module connector 230 is disposed in the connecting module 200, the connecting modules 200 are signal-connected using a specific one second module connector 230 and signal-connected to the learner terminal 500 using the other second module connector 230, and the virtual incubation eggs 100 seated in the respective signal-connected connecting modules 200 are signal-connected to the learner terminal 500 to send or receive data.

In accordance with yet another characteristic of the present invention, there is provided a multi-learning system, including a multi-learning incubation device 300 including a virtual incubation egg 100 formed in a shape of an egg, executing a multi-learning program for incubating and educating a character related to an animal hatched out from the egg, and outputting the multi-learning program and a character image to a screen and a connecting module 200 having the virtual incubation egg 100 seated therein and signal-connected thereto; a main server 400 storing a plurality of pieces of multi-learning content and character information and multi-learning progress data for each learner to be provided to each multi-learning incubation device 300 while operating in conjunction with the multi-learning program; and a learner terminal 500 signal-connected to the multi-learning incubation device 300, accessing the main server 400 over a communication network 10, updating character information and multi-learning progress data for each learner, and providing new multi-learning content according to a lapse of a learning progress or a learner's request.

### Advantageous Effects

As described above, in accordance with the present invention,

a process of generating a character related to an animal hatched out from an egg using the virtual incubation egg 100 and of breeding the character in an image, text, voice or dialogue form in accordance with an incubation process of incubating the actual egg of the corresponding animal by counting time from a point of time at which the corresponding character is generated is displayed. Accordingly, a negative factor that may affect a young learner psychologically and spiritually or erroneous stamping for the sanctity of life due to death or abandonment can be prevented because education for an incubation process or incubation learning is performed and there is no foolproof way of an incubation egg or hatched animal to die to be discarded.

Second, an education effect for various learning can be provided because a learner can learn subject learning, language learning, hobby learning and culture activity learning necessary for the learner, including incubation learning, while a character is educated about the subject learning, language learning, hobby learning and culture activity learning.

Accordingly, the utilization of an incubator can be maximized because various types of learning, such as subject learning, foreign language learning, hobby and cultural life learning, including incubation learning can be learnt through a bred character. If a hatched character is registered with the main server as an avatar of a learner, a lifetime education program, cultural life and a senior citizen dementia prevention program can be performed. Accordingly, an infant, student, an ordinary person, a senior citizen, etc. can learn learning education or language education information.

Third, the plurality of second module connectors 230 having the virtual incubation eggs 100 seated therein and signal-connected together is disposed in the connecting module 200 and is signal-connected using a specific one second module connector 230. The second module connectors 230 are signal-connected to the learner terminal 500 using the other second module connector 230. Accordingly, the virtual incubation eggs 100 seated in the respective signal-connected connecting modules 200 are signal-connected to the learner terminal 500 at the same time and thus can send or receive data. Accordingly, learner convenience can be improved because the learner terminal 500 can be used in such a way as to mount another connecting module 200 on the side of a connecting module 200 connected to the learner terminal 500 without a need to frequently change the virtual incubation egg 100 of each learner in order to connect the virtual incubation egg 100 to the learner terminal 500.

Fourth, a learner can form emotional communication with a character while educating the character through the multi-learning incubation device 300. A learner can be induced to focus on learning education because the degree that a character is bred depending on the degree that the character is educated or managed, thereby being capable of enhancing a learning effect.

Fifth, learning can be performed in a form to dialogize with a character using a learner input signal input through the manipulation means 140 or data extracted from the voice input control module. Accordingly, a learner can continue to be induced to have a continuous attention and interest in learning, and an effect in which emotional communication with a character is performed can be implemented.

### DESCRIPTION OF DRAWINGS

FIG. 1 is a schematic diagram showing the configuration of a multi-learning system according to a preferred embodiment of the present invention,

FIG. 2 is a perspective view showing the state in which a multi-learning incubation device according to a preferred embodiment of the present invention is signal-connected to a learner terminal,

FIG. 3 is a perspective view showing a configuration in which a virtual incubation egg according to a preferred embodiment of the present invention is signal-connected to a connecting module,

FIG. 4 is a perspective view showing an external configuration of the virtual incubation egg according to a preferred embodiment of the present invention,

FIG. 5 is a block diagram showing the functional elements of the virtual incubation egg according to a preferred embodiment of the present invention,

FIGS. 6 and 7 are perspective views showing a configuration in which a plurality of connecting modules according to a preferred embodiment of the present invention are mutually signal-connected, and

FIG. 8 is a schematic diagram for illustrating various functions implemented through the multi-learning system according to a preferred embodiment of the present invention.

### BEST MODE FOR INVENTION

The aforementioned objects, characteristics and advantages of the present invention will become more apparent from the following detailed description. A preferred embodiment of the present invention is described in detail below based on the accompanying drawings.

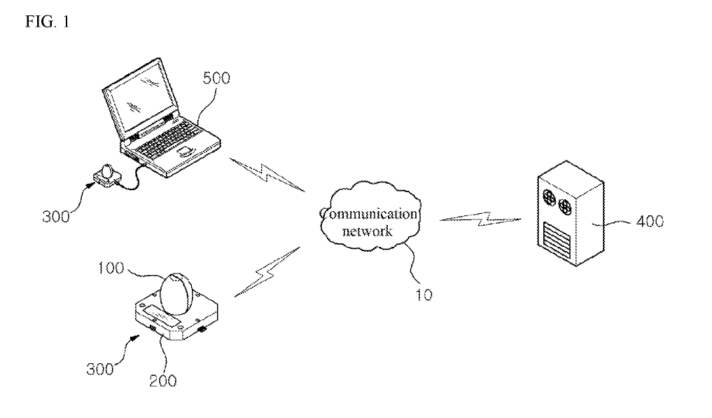

A multi-learning system according to a preferred embodiment of the present invention is a learning providing system capable of generating a character related to an animal hatched out from a corresponding egg using a virtual incubation egg 100 and of learning various types of learning, such as subject learning, foreign language learning and hobby learning, including incubation learning while breeding the corresponding character through learning activities with a learner. The system includes a multi-learning incubation device 300, a main server 400 and a learner terminal 500 as shown in FIG. 1.

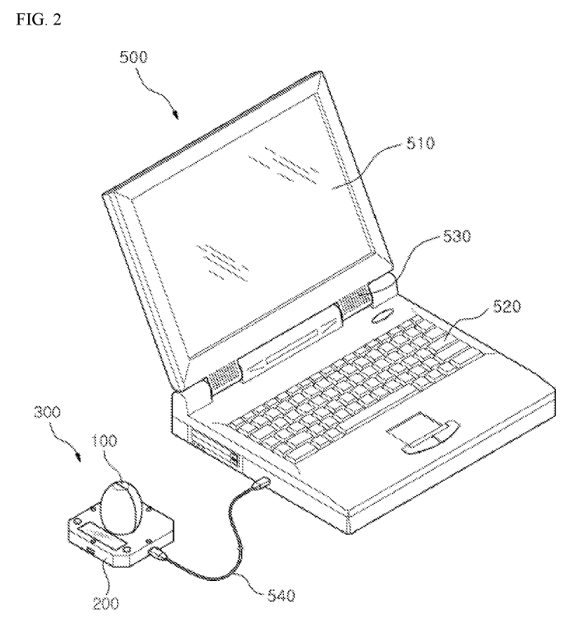

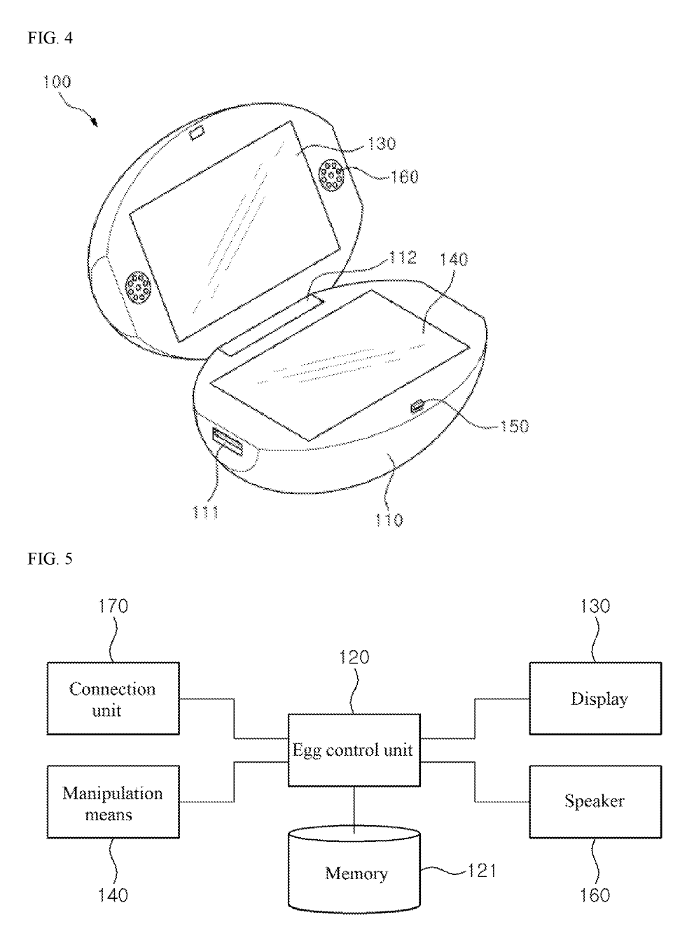

First, the multi-learning incubation device 300 includes the virtual incubation egg 100 and a connecting module 200. In this case, the virtual incubation egg 100 is a virtual incubation egg that substitutes a conventional actual incubation egg. As shown in FIGS. 2 to 5, the virtual incubation egg 100 includes a casing 110 having a shape of an egg and having an egg connector 111 for data input/output mounted on one side thereof, an egg control unit 120 executing a multi-learning program for incubating and educating a character related to an animal hatched out from an egg, a display 130 outputting the executed multi-learning program and a character image, and manipulation means 140 outputting a learner input signal for manipulating the multi-learning program.

In this case, the casing 110 has a shape of an egg and has two part casings formed in a hemispheric type coupled by a hinge 112 and opened or shut in such a way as to widen on both sides. The display 130, the manipulation means 140, etc. may be mounted on the inside of the part casings. Fixing means 150 for selectively fixing the state in which the two part casings have been shut is provided at a portion to which the part casings have been fastened.

Furthermore, the manipulation means 140 is an input device for generating a learner input signal in response to a learner's manipulation, manipulating the multi-learning program and selecting the operation and setting state of the virtual incubation egg 100, and may include a button key, etc. As in the drawings, if the manipulation means is formed of a touch panel, it may be used as an auxiliary display for displaying an image of a button form, selectively sensing the touch operation of each image, and generating a learner input signal and also outputting various screens if necessary.

Furthermore, the egg control unit 120 is formed of a customized IC. It is preferred that the egg connector 111 is provided as a USB method having an information security function so that the character and learning information of a learner are not exposed to the outside.

Furthermore, in relation to the character, a learner can select a specific animal while executing the multi-learning program. The animal may be an oviparous animal, such as birds, reptiles, fishes or insects which are hatched through eggs. It is preferred that the egg connector 111 is the connector terminal of a USB method for an interface with the learner terminal 500 to be described later.

Furthermore, the egg control unit 120 includes memory 121. The memory 121 separately includes a storage space in which specific data can be stored by a learner in addition to a data storage space related to multi-learning according to the present invention so that the virtual incubation egg 100 can be used like portable external memory.

Furthermore, as shown in FIG. 5, the virtual incubation egg 100 includes a connection part 170 connected to a first module connector 220 and a second module connector 230 for receiving various data from the virtual incubation egg 100 and the learner terminal 500 signal-connected thereto through respective connectors and for sending the data of the virtual incubation egg 100, and a speaker 160 for outputting various effect sounds or guide voices in response to the operation and setting state of the virtual incubation egg 100 or the execution of the multi-learning program.

Furthermore, although not shown, a battery for supplying driving power is disposed within the virtual incubation egg 100 as in a common mobile. It is preferred that when the connecting module 200 or the learner terminal 500 is connected through the egg connector 111, the battery is provided to be charged by a charging voltage along with various data signals.

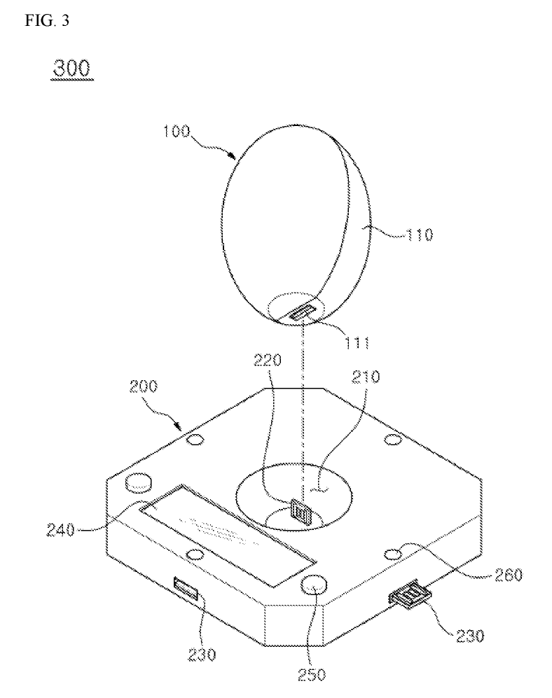

The connecting module 200 is connecting means for connecting the virtual incubation egg 100 signal-connected thereto to the learner terminal 500. As shown in FIGS. 2 and 3, a loading space 210 in which the virtual incubation egg 100 may be disposed is provided in the connecting module 200. The first module connector 220 signal-connected to the egg connector 111 for connecting the module to the virtual incubation egg 100 is disposed within the loading space 210. The second module connector 230 signal-connected to the learner terminal 500 connected to the main server 400 for interlocking the multi-learning program of the virtual incubation egg 100 with the main server 400 is mounted on one side of the connecting module 200.

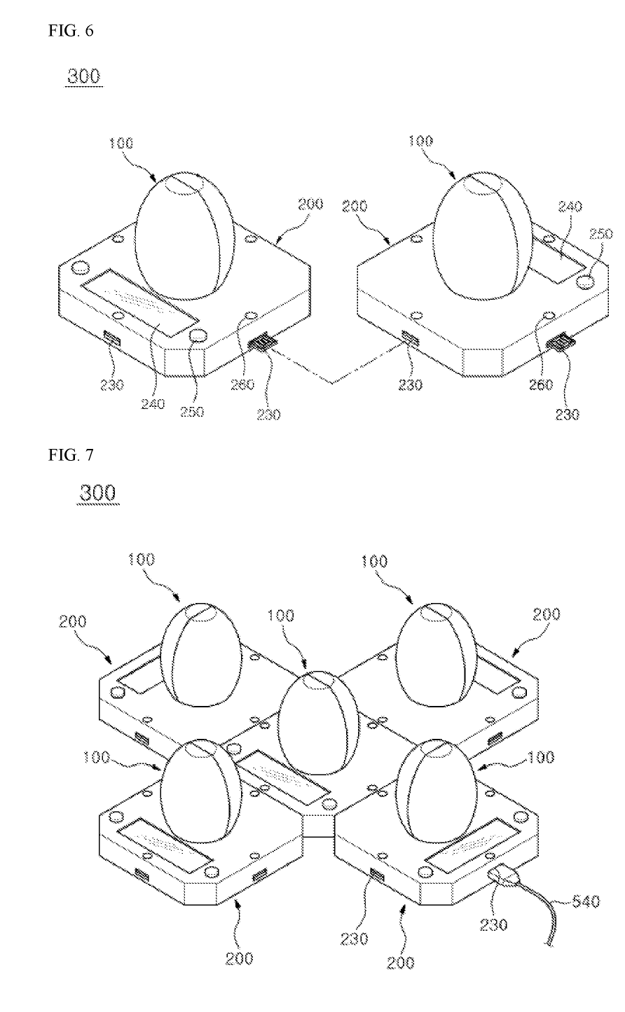

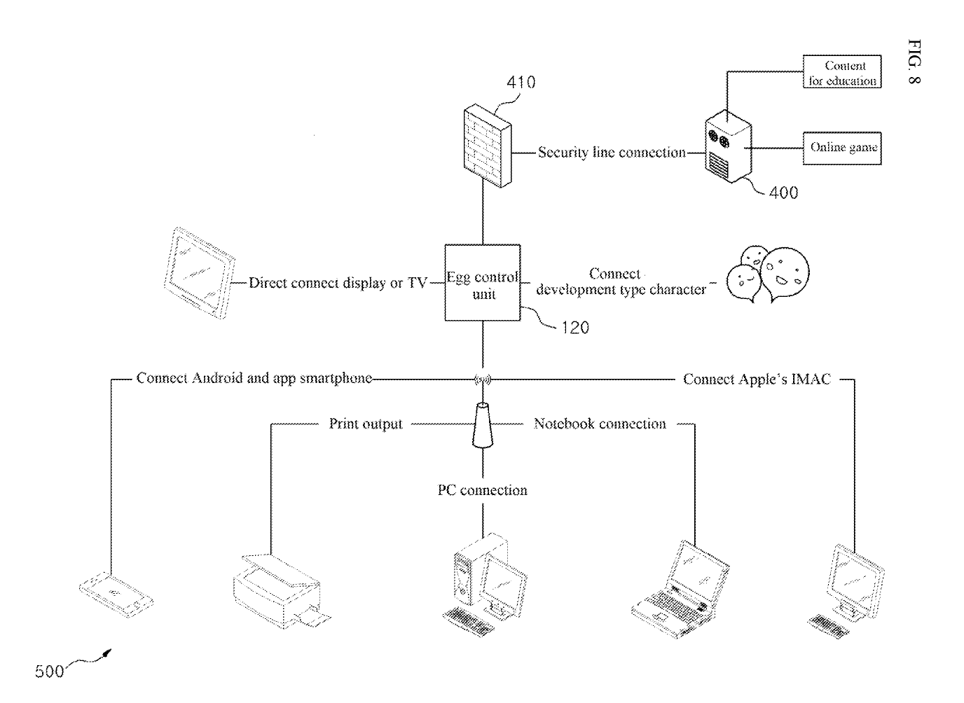

Furthermore, as shown in FIGS. 6 and 7, a plurality of second module connectors 230 is disposed in the connecting module 200. The connecting modules 200 are signal-connected using a specific one second module connector 230 and signal-connected to the learner terminal 500 using the other second module connector 230. Accordingly, the virtual incubation eggs 100 seated in the respective signal-connected connecting modules 200 are signal-connected to the learner terminal 500 to send or receive data.

Accordingly, a learner's convenience can be enhanced because the learner terminal 500 can be used in such a manner that another connecting module 200 is mounted on the side of a connecting module 200 connected to the learner terminal 500 and signal-connected without a need to frequently replace the virtual incubation egg 100 of each earner in order to connect the virtual incubation egg 100 to the learner terminal 500.

Furthermore, as shown in FIG. 3, an indication lamp 260 for indicating a signal connection state with another connecting module 200 or the learner terminal 500 in a turn-on state is disposed at a location close to each second module connector 230 in the connecting module 200. Accordingly, a learner can easily check a connection state between terminals with the naked eye. Manipulation means 250 for manipulating the operation and setting state of the connecting module 200 may be separately provided in the connecting module 200.

Furthermore, a display window 240 for displaying a connection state between terminals or the operation and setting state of a corresponding connecting module 200 or a signal-connected virtual incubation egg 100 may be provided on one side of the connecting module 200. Furthermore, although not shown, an adaptor connector for connecting a power device, such as an adaptor, may be disposed on the other side of the connecting module 200.

The main server 400 is a server in which a plurality of pieces of multi-learning content, character information and multi-learning progress data for each learner to be provided to each multi-learning incubation device 300 while operating in conjunction with the multi-learning program installed on the virtual incubation egg 100 have been stored.

In this case, the main server 400 can separately manage personal information about each learner who has become a member through a member registration procedure, and may provide different learning content to each learner depending on whether a content cost has been paid or not.

Furthermore, as shown in the drawings, the virtual incubation egg 100 may be connected to the main server 400 through the connecting module 200 and the learner terminal 500. If a separate communication module is disposed in the virtual incubation egg 100 or the connecting module 200, the virtual incubation egg 100 may directly access the main server 400 over a communication network 10 without the intervention of the learner terminal 500 and may use various types of multi-learning content.

The learner terminal 500 is communication means for connecting the multi-learning incubation device 300 to the main server 400 and is signal-connected to the multi-learning incubation device 300. The learner terminal 500 accesses the main server 400 over the communication network 10, updates character information and multi-learning progress data for each learner, and provides new multi-learning content according to a lapse of a learning progress or a learner's request.

Furthermore, a notebook or a PC, such as a desktop, may be used as the learner terminal 500 as shown in FIG. 2. In addition, a mobile, such as a smartphone, or a tablet PC may be used as the learner terminal 500.

Furthermore, the learner terminal 500 includes a display 510 outputting various screens, manipulation means 520 generating a learner input signal, a speaker 530 for sound output, etc. The same multi-learning program as that in the virtual incubation egg 100 may be executed in the learner terminal 500, and thus the learner terminal 500 can provide a character and multi-content for the virtual incubation egg 100 connected through the connecting module 200 and interlocked multi-content for incubation and education.

Furthermore, the connecting module 200 and the learner terminal 500 may be signal-connected through an interface connector 540. The loading space 210 has a home shape depressed at the bottom thereof in order to prevent the virtual incubation egg 100 having a round external surface from rolling on the upper side, and can create an atmosphere in which the virtual incubation egg 100 has been stably seated in a nest.

Furthermore, the learner terminal 500 of various forms, including the virtual incubation egg 100, is signal-connected to the main server 400 in which the patch program of the multi-learning program has been stored over the communication network 10 of a wired/wireless communication method, and may update data for various multi-learning contents including incubation learning or change contents. The learner terminal 500 can form a virtual communication space on the Internet based on the main server 400 so that learners can share information or exchange bonds of sympathy.

The main server 400 is a server managed by a management company, such as a development company or education institute or private educational institute, and is connected to the multi-learning incubation device 300 or the learner terminal 500 over the communication network 10. Accordingly, character information and various learning current-condition data generated by a learner can be registered and stored in the main server 400.

Accordingly, as shown in FIG. 8, a generated character is connected and directly connected to a display, TV, etc. capable of connection to the display 130, 510, and thus a process of sounding the character can be displayed in an image, text, voice or dialogue form.

Furthermore, a security program over a network, such as a firewall, is driven in the main server 410 so that only a registered learner can access character information and learning information of the corresponding learner and personal information is not exposed to the outside.

Furthermore, the virtual incubation egg 100 or the learner terminal 500 is signal-connected to a smartphone through the Android system or an application operating in conjunction with the multi-learning program, and thus various types of character incubation and education can be performed. A PC, a notebook or Apple's IMAC may be signal-connected to a smartphone through the multi-learning program installed thereon. Furthermore, the contents of generated character information or learning information are output printing means, such as a printer signal-connected to the virtual incubation egg 100 so that a learner can check the contents through the printed matter.

Furthermore, the main server 400 may store content for education in addition to existing stored various learning information or store an online game program, and may provide the content or online game program to a learner through the multi-learning incubation device 300 and the learner terminal 500.

Meanwhile, in the present embodiment, the virtual incubation egg 200 has been illustrated as being connected to the multi-learning incubation device 300 or each learner terminal 500 in a wired manner through a cable and data is input/output therebetween, but is not limited thereto. If a wireless communication device is disposed within the virtual incubation egg 100 and the learner terminal 500, various data can be input/output through wireless communication means, such as Bluetooth or Wi-Fi.

An operating principle of the multi-learning system according to a preferred embodiment of the present invention is described below.

First, when a learner executes the multi-learning program of the virtual incubation egg 100 or the learner seats a specific virtual incubation egg 100 in the loading space 210 of the connecting module 200 signal-connected to the learner terminal 500 and thus the egg connector 111 and the first module connector 220 are electrically interconnected, this is detected, the multi-learning program is executed, and an initial screen is displayed on the display 130, 510.

When the learner selects the type of animal to be hatched through the manipulation means 140, 520 in the driven multi-learning program, a character related to the selected animal is generated. The generated character information is stored in the memory 121 of the virtual incubation egg 100.

The egg control unit 120 may recognize the hatching date of the corresponding virtual incubation egg 100 from a point of time at which the character was generated and determine information about the incubation progress state and expected incubation date of the virtual incubation egg 100 by checking timing. In contrast, the egg control unit 120 may determine information about the incubation progress state and expected incubation date of the virtual incubation egg 100 based on the hatching date information of the virtual incubation egg 100 that is separately input in response to a learner input signal received through the manipulation means 140.

Accordingly, the character may have a different state in which it is bred depending on the incubation progress state and the expected incubation date. When the expected incubation date is reached, the virtual incubation egg 100 is broken and the character may have a young form of the corresponding animal. The character of a young form gradually grows depending on the progress in which various types of learning are performed by the learner. Furthermore, if the learning progress of the learner is insufficient, the character may restore from the growth step of the current state to a previous growth step or may be bred in the state in which the character is not robust.

Furthermore, a shape of the character may have a virtual character shape generated in a digital image or may have a shape within the egg of a selected actual animal or an actual shape of an animal. This may be displayed through the display 130, 510 and the speaker 114, 530 in a still image, a moving image, text or voice form.

Furthermore, the learner may select desired learning information from various learning categories, such as incubation learning, subject learning, foreign language learning, hobby and cultural life learning provided by the multi-learning program, so the selected learning can be performed through the generated character.

For example, a character may play the role of a thing that provides education and display information related to the learning so that a learner can perform the learning. A learner may play the role of educating a character and perform learning through a method of inputting learning contents known to the learner.

Meanwhile, a learner is provided to perform an emotional exchange with a character. For example, when a learner inputs a term corresponding to daily greeting called “Hi?” through the manipulation means 140, 520 and a microphone, answer information properly corresponding to the term “Hi?” is read from stored answer information, and thus a term “Jongseok˜Hi?” may be displayed on the display 130, 510 or transferred in a voice form through the speaker 114, 530.

Furthermore, when the learner inputs a term related to the state of an incubation environment factor called “Isn't hot?”, if a numerical value is relatively higher than virtual current temperature information based on optimum incubation environment information, a term that guides the proper control details of a current incubation environment factor, such as “It seems a little hot˜will you make it cool?”, is output.

Accordingly, when the learner inputs a learner input signal to lower the virtual current temperature through the manipulation means 140, 520, the virtual current temperature is lowered based on the learner input signal. As described above, if the learner properly takes measures against several incubation environment factors necessary to manage an actual incubation egg, the character can bred at a normal growth speed.

The character information generated as described above and the on-going learning information may be stored in the memory 121 of the virtual incubation egg 100 or the memory of the learner terminal 500, and may be connected to the main server 400 over the communication network 10 through the multi-learning incubation device 300 and stored therein.

Furthermore, the learner may separate the virtual incubation egg 100, may carry it, may connect the virtual incubation egg 100 to the learner terminal 500 in which the multi-learning program is driven, may read a character now being sounded, and may breed the character or perform learning.

In accordance with the elements and functions of the multi-learning incubator 100 according to a preferred embodiment of the present invention described above, a process of generating a character related to an animal hatched out from an egg using the virtual incubation egg 100 and of breeding the character in an image, text, voice or dialogue form in accordance with an incubation process of incubating the actual egg of the corresponding animal by counting time from a point of time at which the corresponding character is generated is displayed. Accordingly, a negative factor that may affect a young learner psychologically and spiritually or erroneous stamping for the sanctity of life due to death or abandonment can be prevented because education for an incubation process or incubation learning is performed and there is no foolproof way of an incubation egg or hatched animal to die to be discarded.

Furthermore, a learner can form emotional communication with a character while educating the character through the multi-learning incubator 300, and the degree that the character is bred is different depending on the degree that the character is educated or managed. Accordingly, a learning effect can be enhanced because the learner focuses on learning education through a character.

Furthermore, learning can be performed in a form to dialogize with a character using a learner input signal input through the manipulation means 140, 520 or data extracted from a voice input control module. Accordingly, a learner can be induced to continue to have an attention and interest in learning and an effect in which an emotional exchange with a character is performed can be implemented.

Meanwhile, the virtual incubation egg 100 or the learner terminal 500 may further include a microphone for inputting the voice signal of a learner and a speaker for outputting the voice of a character, the operation state of the multi-learning incubation device 300, and an effect sound.

Furthermore, the virtual incubation egg 100 or the learner terminal 500 may further include the voice input control module for extracting specific word and sentence information form a learner voice signal input through the microphone and a database for storing answer information for displaying one or more of several pieces of data information, such as daily greeting, incubation learning information, subject learning information, language learning information, hobby learning information, cultural learning information and a dementia motion in accordance with a word and sentence input by the manipulation means 140 or the voice input control module in a dialogue form.

Furthermore, the database stores information about an optimum incubation environment for each type of incubation egg, and stores basic learner information basically input in order to perform an emotional dialogue with a character, such as the name, age, grade, character, etc. of a learner along with the information. Furthermore, information about an incubation progress state and an expected incubation date for each incubation egg, information about another name assigned to each incubation egg by the manipulation means 140, may be additionally stored in the database.

Furthermore, corresponding answer information is extracted from the database 121 in response to a learner input signal input through the manipulation means 140 or data extracted from the voice input control module 122 and controlled so that it is output through the speaker 114.

Accordingly, an education effect for various types of learning can be provide because a learner can learn subject learning, language learning, hobby learning and culture activity learning necessary for the learner in addition to incubation learning related to the incubation process of an egg while educating a character on them.

The present invention described above is not limited to the aforementioned embodiments and the accompanying drawings. It will be evident to those skilled in the art to which the present invention pertains that the present invention may be substituted, modified and changed in various ways without departing from the technological spirit of the present invention

1. A multi-learning incubating device, comprising:
a virtual incubation egg (100) comprising a casing (110) having a shape of an egg and having an egg connector (111) for data input/output mounted on one side thereof, an egg control unit (120) executing a multi-learning program for incubating and educating a character related to an animal hatched out from the egg, a display (130) outputting a executed multi-learning program and a character image, and manipulation means (140) outputting a learner input signal for manipulating the executed multi-learning program; and
a connecting module (200) in which a loading space (210) where the virtual incubation egg (100) is capable of being disposed is prepared, in which a first module connector (220) signal-connected to the egg connector (111) connecting the virtual incubation egg (100) to a module is disposed within the loading space (210), and in which a second module connector (230) signal-connected to a learner terminal (500) connected to a main server (400) for interlocking a multi-learning program of the virtual incubation egg (100) and the main server (400) is disposed on one side thereof.

2. The multi-learning incubation device of claim 1, wherein a plurality of the second module connectors (230) is disposed in the connecting module (200), the connecting modules (200) are signal-connected using a specific one second module connector (230) and signal-connected to the learner terminal (500) using the other second module connector (230), and the virtual incubation eggs (100) seated in the respective signal-connected connecting modules (200) are signal-connected to the learner terminal (500) to send or receive data.

3. A multi-learning incubating device, comprising:
a multi-learning incubation device (300) comprising a virtual incubation egg (100) formed in a shape of an egg, executing a multi-learning program for incubating and educating a character related to an animal hatched out from the egg, and outputting the multi-learning program and a character image to a screen and a connecting module (200) having the virtual incubation egg (100) seated therein and signal-connected thereto;
a main server (400) storing a plurality of multi-learning contents and character information and multi-learning progress data for each learner to be provided to each multi-learning incubation device (300) while operating in conjunction with the multi-learning program; and
a learner terminal (500) signal-connected to the multi-learning incubation device 300, accessing the main server (400) over a communication network (10), updating character information and multi-learning progress data for each learner, and providing new multi-learning contents according to a lapse of a learning progress or a learner's request.
